(19) United States
(12) Patent Application Publication
(10) Pub. No.: US 2021/0142311 A1
(43) Pub. Date: May 13, 2021

(54) SYSTEMS AND METHODS FOR PAYMENT PROCESSING

(71) Applicant: Capital One Services, LLC, McLean, VA (US)

(72) Inventor: Mark Sorbello, Richmond Hill (CA)

(73) Assignee: Capital One Services, LLC, McLean, VA (US)

(21) Appl. No.: 16/679,682

(22) Filed: Nov. 11, 2019

(51) Int. Cl. G06Q 20/32; G06Q 20/38

(52) U.S. Cl. CPC G06Q 20/3224; G06Q 20/3821

(57) ABSTRACT

Systems and methods are disclosed for processing payments. For example, a method may include: receiving, from a mobile device associated with a user, a code and a request to enable the code to be usable to open a payment channel for receiving payment from an account of the user; receiving, from a merchant system associated with a merchant, a request to use the code to open the payment channel; receiving, from the merchant system, information indicative of a payment to be made to an account of the merchant via the payment channel; receiving, from the mobile device, geolocation information indicative of a geolocation of the mobile device; determining whether there is a location match between the geolocation of the mobile device indicated by the geolocation information and a point of sale location of the merchant; and processing the payment.

### TECHNICAL FIELD

Various embodiments of the present disclosure relate generally to payment processing technology and, more particularly, to processing payments made using a customizable code that is used to open a payment channel.

### BACKGROUND

A customer may desire the ability to make payments from a credit card account, for example, without having to physically use the credit card at a merchant. For example, the customer may desire to make payments without exposing the credit card number. Additionally, in certain situations such as a drive-through transaction, it may be inconvenient for the customer to physically provide his or her credit card to a merchant. Therefore, there is a need for systems and methods that facilitate payment using a credit card account without requiring physical use of the credit card.

The present disclosure is directed to addressing one or more of these above-referenced challenges. The background description provided herein is for the purpose of generally presenting the context of the disclosure. Unless otherwise indicated herein, the materials described in this section are not prior art to the claims in this application and are not admitted to be prior art, or suggestions of the prior art, by inclusion in this section.

### SUMMARY OF THE DISCLOSURE

According to certain aspects of the disclosure, systems and methods are disclosed for processing payments.

For example, a method may include: receiving, from a mobile device associated with a user, a code and a request to enable the code to be usable to open a payment channel for receiving payment from an account of the user; receiving, from a merchant system associated with a merchant, a request to use the code to open the payment channel, the code being identifiable from the request to use the code to open the payment channel; receiving, from the merchant system, information indicative of a payment to be made to an account of the merchant via the payment channel; sending, to the mobile device, a request to provide geolocation information indicative of a geolocation of the mobile device; receiving, from the mobile device, the geolocation information; determining whether one or more conditions for payment verification are satisfied, the one or more conditions including a location match between the geolocation of the mobile device indicated by the geolocation information and a point of sale location of the merchant; and upon determining that the one or more conditions for payment verification are satisfied, processing the payment.

Furthermore, a method may include: receiving, from a merchant system associated with a merchant, a code and a request to enable the code to be usable to open a payment channel for making payments to an account of the merchant; receiving, from a mobile device associated with a user, a request to use the code to open the payment channel, the code being identifiable from the request to use the code to open the payment channel; receiving, from the merchant system, information indicative of a payment to be made to the account of the merchant via the payment channel; sending, to the mobile device, a request to provide geolocation information indicative of a geolocation of the mobile device; receiving, from the mobile device, the geolocation information; determining whether one or more conditions for payment verification are satisfied, the one or more conditions including a location match between the geolocation of the mobile device indicated by the geolocation information and a point of sale location of the merchant; and upon determining that the one or more conditions for payment verification are satisfied, processing the payment.

Furthermore a computer system may include a memory storing instructions and a code associated with an account of a first party; and one or more processors configured to execute the instructions to perform operations. The operations may include: receiving, from a computer system associated with a second party, a request to use the code to open a payment channel associated with the account of the first party, the code being identifiable from the request; receiving, from the computer system, information describing a payment to be made via the payment channel as part of a transaction between the first party and the second party, wherein one of the first party and the second party is a customer associated with a mobile device, and another of the first party and the second party is a merchant; sending, to the mobile device, a request to provide geolocation information indicative of a location of the mobile device; receiving, from the mobile device, the geolocation information; determining whether one or more conditions for payment verification are satisfied, the one or more conditions including a location match between the location of the mobile device indicated by the geolocation information and a point of sale location of the merchant; and upon determining that the one or more conditions for payment verification are satisfied, processing the payment.

Additional objects and advantages of the disclosed embodiments will be set forth in part in the description that follows, and in part will be apparent from the description, or may be learned by practice of the disclosed embodiments.

It is to be understood that both the foregoing general description and the following detailed description are exemplary and explanatory only and are not restrictive of the disclosed embodiments, as claimed.

### BRIEF DESCRIPTION OF THE DRAWINGS

The accompanying drawings, which are incorporated in and constitute a part of this specification, illustrate various exemplary embodiments and together with the description, serve to explain the principles of the disclosed embodiments.

FIG. 1 depicts an exemplary system environment for payment processing, according to one or more embodiments.

FIG. 2 depicts a method for payment processing, according to one or more embodiments.

FIG. 3 depicts a method for payment processing, according to one or more embodiments.

FIG. 4 depicts a method for payment processing, according to one or more embodiments.

FIG. 5 depicts a method for payment processing, according to one or more embodiments.

FIG. 6 depicts an exemplary computing device, according to one or more embodiments.

### DETAILED DESCRIPTION OF EMBODIMENTS

The terminology used below may be interpreted in its broadest reasonable manner, even though it is being used in conjunction with a detailed description of certain specific examples of the present disclosure. Indeed, certain terms may even be emphasized below; however, any terminology intended to be interpreted in any restricted manner will be overtly and specifically defined as such in this Detailed Description section. Both the foregoing general description and the following detailed description are exemplary and explanatory only and are not restrictive of the features, as claimed.

In this disclosure, the term “based on” means “based at least in part on.” The singular forms “a,” “an,” and “the” include plural referents unless the context dictates otherwise. The term “exemplary” is used in the sense of “example” rather than “ideal.” The terms “comprises,” “comprising,” “includes,” “including,” or other variations thereof, are intended to cover a non-exclusive inclusion such that a process, method, or product that comprises a list of elements does not necessarily include only those elements, but may include other elements not expressly listed or inherent to such a process, method, article, or apparatus. Relative terms, such as, “substantially” and “generally,” are used to indicate a possible variation of ±10% of a stated or understood value.

In the following description, embodiments will be described with reference to the accompanying drawings. As will be discussed in more detail below, a code that is usable to open a payment channel may be provided by one party (such as a customer) to another party (such a merchant). If the party receiving the code is the merchant, then the merchant may, upon receiving the code, transmit the code to a payment processing system along with a payment authorization request. The payment processing system, which may be a server system, may recognize the code as indicating that payment is to be made from an account of the customer that is associated with the code. The payment processing system may perform authentication, such as determining whether a user device of the user, such as a smartphone, is within a certain geographical proximity from the point of sale. If authentication of the requested payment is successful, the payment processing system may process the payment requested by the merchant. The code may substitute for a credit card, for example. Accordingly, the customer may make a payment without handing over the credit card.

FIG. 1 illustrates a system environment 100 for payment processing. System environment 100 may include a user device 110 operated by user 105, a server system 120, and a merchant system 142 operated by merchant 140. User device 110 and merchant system 142 may communicate with server system 120 through communication network 150, which may be one or a combination of public networks (e.g., the Internet), local networks, and/or other networks.

User device 110 be any suitable computer system. Examples of computer systems that may serve as user device 110 include smartphones, tablet computers, wearable computing devices, handheld computing devices, laptop computers, and other mobile computing devices. User device 110 may have any combination of software and/or hardware enabling user device 110 to determine its current geographic location. In this disclosure, a geographic location is also referred to as “geolocation.” The geolocation of user device 110 may be used by server system 120 to verify that user 105 is within a certain geographical proximity to a point of sale location of merchant 140, as will be described below in more detail.

User device 110 may use any suitable method or combination of methods to determine its geolocation. For example, user device 110 may include a global positioning system (GPS) and may determine its current geolocation using the GPS. Additionally or alternatively, user device 110 may determine its current geolocation based on signals received from a base station of a cellular network, if user device 110 includes cellular communications capabilities, and/or based on information received from external computer systems such as a network router or internet service provider.

User 105, who operates user device 110, may be a person with a financial account. A financial account may be, for example, a credit or debit card account that is maintained by an issuer. An issuer may be a bank or other payment card issuer. The financial account maintained by the issuer for user 105 may have a primary account number (PAN). As will be described below in more detail, in some embodiments, merchant 140 may accept payment from user 105 using a code for payment use that is associated with the financial account of the user. Such a code may also be referred to as a payment code, a code for payment channel access, or a payment channel access code. User 105 may also be referred to as a customer of merchant 140.

Merchant 140 may be any entity that provides a product for purchase by user 105. In this disclosure, the term “product,” in the context of products offered by a merchant, may encompass both goods and services, as well as products that are a combination of goods and services. A merchant may be, for example, a retailer, a grocery store, an entertainment venue operator, a service provider, a restaurant, a bar, a non-profit organization, or other type of entity that provides products that a consumer such as user 105 may consume. Merchant 140 may have one or more venues, such as venue 146 shown in FIG. 1, that a consumer may physically visit in order to obtain the products (goods or services) offered by the merchant 140. In this context, a venue may be a facility such as a “brick-and-mortar” store.

Merchant 140 may accept payment from user 105 for products offered by merchant 140. Accordingly, merchant 140 may have a financial account for purposes of accepting payments. The financial account of merchant 140 may be maintained by an acquirer. While a code for payment use may be associated with the financial account of user 105, as described above, the code may instead be associated with the financial account of merchant 140, in which case merchant 140 may provide user 105 with a code in order to open a payment channel permitting payment to the merchant's financial account.

Merchant system 142 may be any suitable computer system that is operated by merchant 140. Merchant system 142 may be, for example, a desktop computer, a mobile computing device (e.g., of the types described above), or a point of sale terminal (e.g., credit card terminal) of any suitable form. The point of sale terminal may be configured to output or input a payment code, as described in this disclosure. In various embodiments, merchant system 142 may be configured to receive payments from user 105 via the payment code.

Merchant 140 may operate merchant system 142 via merchant agent 144. Merchant agent 144 may represent one or more persons that perform manual operations on merchant system 142, such as the input of information into merchant system 142 or the conveyance of information from merchant system 142 to user 105. Merchant agent 144 may include, for example, an employee, contractor, or other agent of merchant 140. Merchant agent 144 may be located in or at venue 146, in which case merchant agent 144 may be, for example, a store clerk or customer service agent.

Server system 120 may represent any suitable computer system that processes payments made using the aforementioned code for payment use. Server system 120 may be operated by any suitable organization that provides, or is involved in providing, a service permitting payments using a code as described in this disclosure. Such an organization may be, for example, a payment service provider, an issuer (e.g., the aforementioned issuer that maintains the financial account for user 105), an issuing processor, an acquirer, an acquiring processor, and/or a payment gateway. Server system 120 may be a computer system of any suitable form. For example, server system 120 may have a cloud computing platform with scalable resources for computations and/or data storage, and may run one or more applications on the cloud computing platform to perform the functionalities described in this disclosure. Server system 120 may also be a plurality of such computer systems, as described above, that are respectively operated by a plurality of organizations of the types described above.

Server system 120 may also be referred to as a payment processing system, or in general terms, a computer system. Since server system 120 may perform authentication of a requested payment, server system 120 may also be referred to as a payment authentication system. Where context permits, the term “payment authentication” may encompass concepts of payment verification and identity verification in the sense of verifying an identity of a party making or receiving payment.

As shown in FIG. 1, user 105 and merchant 140 may communicate with one another to provide a code for payment use. A code for payment use may be a code, provided by one party (either user 105 or merchant 140) to the other party to enable the other party to open a payment channel. The payment channel may enable payments from one party to the other (e.g., from user 105 to merchant 140).

As described above, the code for payment use may be associated with a financial account, which may be an account of user 105 or an account of merchant 140. For example, the code for payment use may be associated with the financial account of the user 105 maintained by the aforementioned issuer, in which case the user may communicate the code to merchant 140 in order to make a payment from that financial account to a financial account of merchant 140. Alternatively, the code for payment use may be associated with the financial account of merchant 140, in which case merchant 140 may communicate the code to user 105 in order to permit the user 105 to make a payment to that financial account of merchant 140.

User 105 may communicate the code for payment use to merchant 140, or vice versa, via user device 110, merchant system 142, and/or merchant agent 144. For example, if user 105 is to communicate a code to merchant 140, user 105 may verbally communicate the code to merchant agent 144, display the code in a manner such that the code is electronically readable by merchant system 142 or human-readable by merchant agent 144, and/or operate user device 110 to electronically communicate the code to merchant system 142. If the code is communicated to merchant agent 144, merchant agent may manually enter the code into merchant system 142.

Similarly, if merchant 140 is to communicate the code to user 105, merchant agent 144 may, for example, verbally communicate the code to merchant agent 144, display the code in a manner such that the code is electronically readable by user device 110 or human-readable by user 105, and/or operate merchant system 142 to electronically communicate the code to user device 110. If the code is communicated to user 105, user 105 may manually enter the code into user device 110.

The code for payment use may have any suitable format. The format may depend on the manner in which it is communicated from one party to the other party. For example, if the code is to be communicated verbally, it may have a length and format that is suitable for verbal communication, such as a sequence of several (e.g., four to eight) alphanumeric characters. It is also possible for the code to be sequence of words. In various embodiments, the code for payment use may, in general, be something other than the PAN of the financial account associated with the code, such that disclosure of the PAN may be avoided.

A display of the code in an electronically-readable manner may include a display of the code as an image that is readable with the use of a camera and image processing software. For example, merchant 140 may display the code as a QR code image, and user device 110 may be configured to read the QR code using a camera of user device 110. Electronic communication between merchant system 142 and user device 110 for purposes of communication of the code may utilize network 150, a local wireless network (e.g., a wireless network of a venue 146 of merchant 140 at which user 105 is shopping), and/or through short range communication (e.g., Bluetooth communication or Near Field Communication).

As described above, the display of the code for payment use may be human-readable. For example, venue 146 operated by merchant 140 may be a drive-through store, and the license plate numbers of the vehicles of customers may serve as codes for making payment to merchant 140. As a customer, user 105 may use his or her vehicle's license plate number as the code. Since the vehicle's license plate number may be visible to merchant agent 144 while user 105 is at venue 146, user 105 may utilize the license plate as a public display of the code for merchant 140. Merchant agent 144 may then read the code from the license plate and input the code into merchant system 142. Alternatively, user 105 may communicate the code to merchant agent 144 verbally.

The code for payment use may be used for a one-time transaction or for a series of related transactions between user 105 and merchant 140. Additionally, the code for payment use may be usable for a set duration of time, or instead be usable for an indefinite duration of time.

Once the code for payment use has been provided by one party to the other party, the receiving party may transmit the code to server system 120 along with a request to use the code for payment. Server system 120 may then perform verification of the payment.

A series of related transactions may be a series of purchases or purchase requests made by user 105 that is be paid for under a single bill. For example, merchant 140 may be a bar operator, venue 146 may be a bar, and merchant agent 144 may be a bartender at the bar. To open a bar tab, user 105 may verbally communicate a code, usable to open a payment channel permitting payment from user 105's financial account, to the merchant agent 144. Merchant agent 144 may submit the code to server system 120 to open the payment channel (e.g., in the manner described below in connection with step 205 of FIG. 2). Whenever user 105 orders a new drink or other item at the bar, merchant agent 144 may submit a bill item corresponding to the new drink or item to server system 120. Server system 120 may track the addition of new bill items, and may transmit data to user device 110 describing each bill item that has been added to the bill. Such data may be transmitted whenever a new bill item has been submitted by merchant agent 144 to server system 120, such that user 105 may keep track of the bill in real time. At some point, merchant agent 144 may request processing of the bill by sending a payment authorization request to server system 120 (e.g., in the manner described below in connection with step 206 of FIG. 2). It is noted that instead of user 105 providing the code to merchant agent 144, it is also possible for merchant agent 144 to provide the code to user 105, in which case the code may be associated with the financial account of merchant 140 as a payment destination.

Accordingly, a customer-selected code may be used to create and open a payment channel, either for a single transaction such as a drive-through transaction or for a longer duration such as for opening a tab at a bar. The payment channel for longer-term channels may also be monitored by the user for fraud. Fraud monitoring may offer options for the user 105 to dispute any transactions occurred in the payment channel as well as enable dispute resolution by the merchants and the server system 120. For example, at a predetermined time period (e.g., at the end of every month) the user may be presented with an itemized list of all transactions within the predetermined time period. The user 105 may review the list of all transactions and flag transactions that may not be authorized by the user. The user 105 may flag the transaction via the user device 110 or by contacting the server system 120. Upon flagging one or more transaction as not authorized, the merchant 140 associated with the transaction(s) may receive a notification that a user has flagged the transaction as not authorized. The server system 120 may offer the merchant 140 methods to resolve the flagged transaction. For example, the merchant 140 may provide proof that the user 105 authorized the transaction, or the merchant 140 may remove the charges.

In addition to transaction dispute and dispute resolution, fraud monitoring may also include periodic user approvals. For example, in the embodiment above of the user 105 opening a tab at a bar, periodic user approvals may be requested to the user at a predetermined monetary increments (e.g., for every $50 increase in the tab, a notification may be sent to the user device 110 to request the user 105 to approve the continuance of the tab). If user 105 approves the periodic requests, the server system 120 may continue to allow transactions to be added to the bill of the user 105. If user 105 does not approve the periodic requests, then the server system 120 may prevent any further transaction to be added to the bill of the user 105 and provide a notification to the merchant 140 or the merchant agent 144.

In another embodiment, the server system 120 may allow the user 105 to initiate payments related to the transactions but not specifically for the transaction. For example, the server system 120 may allow the user to add a monetary value to a transaction as a tip to the merchant agent 144. In the example discussed above regarding the bar tab, when the merchant agent 144 requests the processing of the bill by sending a payment authorization request to server system 120, the server system 120 may enable the user 105 to add a monetary value in addition to the total transaction amount.

Methods for performing payment transaction using such codes are described below in more detail with reference to FIGS. 2 and 3. In general, the methods of FIGS. 2 and 3 may utilize the techniques described above in connection with FIG. 1.

FIG. 2 depicts an exemplary method for payment processing in which the code for payment use is provided by a user for a merchant. The method of FIG. 2 may involve user 105, user device 110, server system 120, merchant 140, and merchant system 142. In the method shown in FIG. 2, user 105 may communicate a code to merchant 140 in order to make a payment to the merchant 140. Upon receiving the code, merchant 140 may then use the code to open a payment channel permitting payment from a financial account of user 105, as described below in more detail.

In step 201, user device 110 may provide a code to server system 120. In step 201, the code may be transmitted to server system 120 as part of, or along with, a code registration request requesting server system 120 to enable the code to be usable by another party, such as merchant 140, to open a payment channel for receiving payment from a financial account of the user 105.

The code may be created or specified by user 105, in which case user 105 may input the code into user device 110. For example, user 105 may enter the license plate number into user device 110, and user device 110 may provide the code to server system 120 as part of a request to enable the code be usable for payment use. It is also possible for the code to be automatically generated by user device 110 (e.g., generated as a randomly assembled sequence of characters), in which case user device 110 may send the code directly to server system 120 after confirmation by user 105, or may do so without user 105's confirmation.

User device 110 may execute an application enabling user 105 to perform step 201 on user device 110. For example, the application may be a banking application or payment service application that permits user 105 to specify or generate the code, identify the financial account to be associated with the code, and transmit, to server system 120, the aforementioned code registration request indicative of the code and the financial account.

In step 202, server system 120 may associate the code received from user device 110 with the aforementioned financial account of user 105. For example, server system 120 may store the code in a database in a manner that permits the financial account of user 105 to be identified when the code is given by a party, such as merchant 140, for payment use.

Steps 201 and 202 may be regarded as a registration process by which a code provided by user device 110 is registered so that it is usable by another party (such as merchant 140) for purposes of opening a payment channel that enables payments to be made from the financial account associated with the code. After the registration process has been completed, user 105 may utilize the code to make a payment to the merchant 140 by communicating the code to merchant 140, as shown in step 203. As described above, user 105 may communicate the code to merchant 140 in any suitable manner of communication.

In step 204, merchant system 142 may receive the code via any suitable intermediary, such as merchant agent 144 and/or from user device 110. For example, as described above, the code may be communicated from user 105 to merchant agent 144, in which case merchant agent 144 may input the code into merchant system 142. It is also possible, for example, for the code to be communicated from user device 110 to merchant system 142 through electronic method, such as communication via a local network or near-field communication.

In step 205, merchant system 142 may provide the code to server system 120 to open a payment channel for receiving payment from user 105. In step 205, merchant 142 may transmit a request to use the code to open the payment channel for receiving payment from the financial account of the user 105. The code may be indicated by, or otherwise identifiable from, the request.

In step 206, merchant system 142 may send a payment authorization request to server system 120. The payment authorization request may include payment information describing the payment that is to be made to a receiving financial account of merchant 140 via the payment channel. For example, the payment information may describe the parties involved in the transaction, the amount of payment, and the goods or services exchanged for the payment. The payment authorization request may be any request that is recognized by server system 120 as requesting the processing of payment as described by the payment information.

As described above, the code may be used for a payment of a bill pertaining to a series of related transactions. In this case, after step 205, merchant system 142 may transmit a plurality of transaction descriptions, each corresponding to an individual transaction and describing a bill item having a charge for that transaction. For example, in the bar tab scenario discussed above, each transaction description may describe a drink or other item purchased by user 105 at the bar, prior to finalization of the bill of the bar tab. As described above, server system 120 may inform user device 110 in real-time of each item that is added to the bill in response to receiving the corresponding transaction description. For example, upon receiving the transaction description of each the bill item, merchant system 142 may send, to user device 110, information describing the bill item so that the user device 110 is usable to monitor updates to the bill.

If the code is instead used for payment for only a single transaction, such as a single drive-through purchase, steps 205 and 206 may be performed concurrently (e.g., as a single step). In this case, the code and any description of the transaction may be included as part of the payment authorization request.

In step 207, server system 120 may, in response to receiving the payment authorization request in step 206, request geolocation and approval of the payment from user device 110. For example, server system 120 may transmit, to user device 110, a request to provide geolocation information indicative of a geolocation of the user device 110. Server system 120 may also request user device 110 to provide approval of the payment, which may be the same request as the request to provide geolocation information, or a different request. The geolocation and the approval of the payment may be requested concurrently (e.g., as part of the same request) or separate (e.g., using separate respective requests).

Upon receiving a request to provide geolocation, user device 110 may determine its current geolocation, as described above in connection with FIG. 1, and transmit the requested geolocation information, which indicates the determined geolocation, to server system 120 at step 208. The geolocation information may, for example, indicate the determined geolocation using a set of geographical coordinates determined by user device 110.

Furthermore, upon receiving a request to provide approval of payment, user device 110 may prompt user 105 to confirm approval of the payment. For example, user device 110 may present, to user 105 the amount of the payment requested and the identity of the merchant 140 requesting the payment. User device 110 may prompt user 105 to input a confirmation of the approval.

In step 208, user device 110 may provide the geolocation and approval of payment. For example, user device 110 may transmit the aforementioned geolocation information and a message indicating approval of the payment to server system 120. The geolocation information and the approval of payment may be provided concurrently (e.g., as part of the same message transmitted to server system 120), or separately.

In some embodiments, approval of payment by user 105 may be optional. For example, server system 120 may be configured to skip the payment approval process, in which case server system 120 may request only the geolocation without requesting approval of the payment. Whether approval of the payment is required or not, or the conditions under which approval of the payment is required (e.g., a payment amount above a certain threshold, or a requesting merchant that is not within a specified group of merchants), may be set by the user 105 (e.g., specified as part of the code registration request, or specified afterwards). For example, in the drive-through transaction example described above in which the code is publicly visible, seeking express approval of the payment from user device 110 may provide an additional layer of security.

The determination and transmission of the geolocation information by user device 110 to server system 120 may be performed automatically by user device 110 in response to receiving the request for geolocation information. Alternatively, the determination and/or transmission of the geolocation information may be performed in response to a user command, such as a user command in response to a prompt for permission to transmit the geolocation information.

Upon receiving the geolocation and the approval of payment, server system 120 may perform an authentication process of determining whether the payment requested by merchant system 142 is authentic. The authentication process may also be referred to as a payment verification process or as an identity verification process. The payment requested by merchant system 142 may be deemed to be verified if one or more conditions are satisfied. In the method of FIG. 2, for example, such conditions may include a successful geolocation verification (step 209) and a successful verification that the code has not expired (step 210), as described below.

In step 209, server system 120 may verify the user device geolocation indicated by the geolocation information received from user device 110. This verification may include determining whether there is a match between the geolocation of the mobile device indicated by the geolocation information and a point of sale location of the merchant 140. Verification may be successful if there is a match, and unsuccessful if there is no match.

In step 209, the point of sale location of the merchant 140 may be, for example, a location of venue 146 of merchant 140 at which user 105 (who possesses user device 110) is performing the purchase transaction, or a location of a point of sale terminal represented by merchant system 142. The point of sale location (e.g., location of a venue or point of sale terminal) may be stored in a database of server system 120 prior to performing the method of FIG. 2, and may be retrieved from such a database for comparison with the user device geolocation provided by user device 110. The point of sale location may be a geolocation, which may be represented as a set of geographic coordinates.

Whether the geolocation of the user device 110 matches the point of sale location of the merchant 140 may be determined based on any suitable criterion or criteria for determining a match between two locations. For example, the two locations may be deemed to be matching if the distance between the two locations (e.g., distance as calculated based on their respective geographic coordinates) are within a certain threshold distance (e.g., 25 meters).

A location match may indicate that user 105 was present at the venue 146 of merchant 140, which in turn indicates that the payment was authorized by user 105 (as opposed to an unauthorized party). The lack of a location match may indicate that user 105 was not present at the venue 146, which in turn indicates that the code provided by merchant 140 was not obtained with permission from user 105.

In some embodiments, user 105 or user device 110 may specify that the code may expire if a certain length of time or period of time has elapsed. This condition for expiration may be specified by of the code registration request in step 201, or at any suitable point of time afterwards. In such embodiments, the one or more conditions for authentication may further include a successful determination that the code has not expired. In such embodiments, server system 120 may perform step 211, in which server system 120 verifies non-expiration of the code. For example, server system 120 may receive, from user device 110, a time limit corresponding to a period of time during which the code is usable for payment. That is, if the code is used outside of (e.g., beyond or past a maximum time) this time limit, server system 120 may determine that the code has expired.

In step 210, server system 120 may determine whether receipt of the request to use the code to open the payment channel (pursuant to step 205) occurred within the period of time, wherein a determination of “yes” results in successful verification of non-expiration. Alternatively, server system 120 may determine whether receipt of the payment authorization request (pursuant to step 206) occurred during this period of time, wherein a determination of “yes” results in successful verification of non-expiration.

As described above, the payment authentication may be successful if the one or more conditions for authentication are satisfied. If there are multiple conditions for authentication, then payment authentication may be successful if each one of the conditions is satisfied.

If payment authentication is successful, server system 120 may process the requested payment in step 211. The act of processing the requested payment may include any operation resulting in the payment being made. For example, if server system 120 is part of a service that is separate from the issuer that maintains the financial account of user 105, then server system may transmit, to the issuer, transaction information describing the payment and associated transaction. The issuer may then continue the processing of the payment by sending an approval message to the acquirer. This description may identify the financial account of the user 105 from which the payment is to be made.

In the method illustrated in FIG. 2, where the code is associated with a financial account of user 105, the processing of the requested payment may result in a transfer of funds, of the amount specified by the payment authorization request sent in step 206, from the financial account of user 105 to the financial account of merchant 140.

FIG. 3 depicts another exemplary method for payment processing transactions. In the method of FIG. 3, the code for payment use is provided by a merchant for a user, instead of being provided by the user to the merchant, as in the case of the method of FIG. 2. However, with the respective differences having been considered, techniques described for FIG. 2 may be used in the method of FIG. 3, wherever applicable. As in the case of FIG. 2, the method of FIG. 3 may involve user 105, user device 110, server system 120, merchant 140, and merchant system 142.

In step 301, merchant system 142 may provide a code to server system 120. Step 301 may be performed analogously to step 201, except that merchant system 142 and merchant operator 144 may take the role of user device 110 and user 105 as described for step 201. In step 301, the code may be transmitted to server system 120 along with, or as part of, a code registration request requesting server system 120 to enable the code be usable by another party, such as merchant 140, to open a payment channel for receiving payment from a financial account of the user. The code may be created or specified by merchant agent 144, in which case user 105 may input the code into user device 110, or may be automatically generated by merchant system 142.

In step 302, server system 120 may associate the code received from merchant system 142 with a financial account of merchant 140. For example, server system 120 may store the code in a database in a manner that permits the financial account of user 105 to be identified when the code given by a party (such as user 105) for purposes of opening a payment channel that enables payments to be made to the financial account associated with the code. Steps 301 and 302 may be regarded as a registration process by which a code provided by merchant system 142 is registered so that it is usable in such a manner.

In step 303, merchant 140 may communicate the code to user 105 for payment use. As described above, merchant 140 may communicate the code to user 105 using any suitable manner of communication.

In step 304, user device 110 may receive the code. For example, the code may be communicated from merchant agent 144 to user 105, in which case user 105 may input the code into user device 110. It is also possible, for example, for the code to be communicated to user device 110 by merchant system 142 through an electronic method, such as communication via a local network or near-field communication.

In step 305, user device 110 may provide the code to server system 120 to open a payment channel for making a payment to merchant 140. In step 305, user device 110 may transmit a request use the code to open the payment channel for receiving payment from the financial account of the user. The code may be indicated by, or otherwise identifiable from, the request.

In step 305, user device 110 may also provide server system 120 with information identifying a financial account of user 105 from which the payment is to be made. Alternatively, the financial account of user 105 from which the payment is to be made may be a pre-set configuration that is selected as a default by server system 120 whenever user device 110 provides a code to make a payment.

Subsequently, in step 306, merchant system 142 may send a payment authorization request to server system 120. In step 307, server system 120 may, in response to receiving the payment authorization request in step 306, request geolocation and approval of the payment from user device 110. In step 308, user device 110 may provide the geolocation and approval of payment. In step 309, server system 120 may verify the user device geolocation indicated by the geolocation information received from user device 110. In step 310, server system 120 may determine whether receipt of the request to use the code to open the payment channel (pursuant to step 205) occurred within the period of time. Steps 305 to 310 may be performed in the manner of steps 206 to 210 as described above. In general, and any techniques described in connection steps 206 to 210 may be applied to steps 305 to 310. It is noted, however, that if step 310 is performed, the condition for expiration may be set by merchant system 142 at step 301.

Steps 309 and 310 may be part of a payment authentication process. If payment authentication is successful, server system 120 may process the requested payment in step 311. The techniques described for step 211 may be used in step 311.

It is noted that the user device 110, server system 120, and merchant system 142 may be configured for performing both the method of FIG. 2 and the method of FIG. 3, and may perform them under different usage circumstances.

FIG. 4 is a flowchart depicting a method 400 for payment processing, according to one or more embodiments. The method 400 may be performed by any suitable computer system, such as server system 120. In general, the method 400 of FIG. 4 may utilize the techniques described above in connection with FIGS. 1 and 2.

Step 401 may include receiving, from a mobile device associated with a user, a code and a request to enable the code to be usable to open a payment channel for receiving payment from an account of the user. The mobile device may be represented by user device 110 described above. Mobile device may send the code and request in the manner of step 201 of FIG. 2.

Step 402 may include receiving, from a merchant system (e.g., merchant system 142) associated with a merchant, a request to use the code to open the payment channel. For example, merchant system 142 may provide the code in accordance with step 205 of FIG. 2.

Step 403 may include receiving, from the merchant system, information indicative of a payment to be made to an account of the merchant via the payment channel. For example, merchant system 142 may provide payment information in accordance with step 206 of FIG. 2.

Step 404 may include sending, to the mobile device, a request to provide geolocation information indicative of a geolocation of the mobile device. Step 405 may include receiving, from the mobile device, the geolocation information. Steps 404 and 405 may be performed in accordance with steps 207 and 208, respectively, of FIG. 2.

Step 406 may include determining whether condition(s) for payment verification are satisfied. Such condition(s) may include a location match between the geolocation of the mobile device and a point of sale location of the merchant. The location of the mobile device and the point of sale location may be geolocations, and may be verified in accordance with step 209 of FIG. 2.

Step 407 may include, upon determining that the condition(s) for payment verification are satisfied, processing the payment. Step 407 may be performed in accordance with step 211 of FIG. 2.

FIG. 5 is a flowchart depicting a method 500 for payment processing, according to one or more embodiments. The method 500 may be performed by any suitable computer system, such as server system 120. In general, the method 500 of FIG. 5 may utilize the techniques described above in connection with FIGS. 1 and 3.

Step 501 may include receiving, from a merchant system (e.g., merchant system 142) associated with a merchant (e.g., merchant 140), a code and a request to enable the code to be usable to open a payment channel for making payments to an account of the merchant 140. Merchant system 142 may provide the code in accordance with step 301 of FIG. 2.

Step 502 may include receiving, from a mobile device associated with a user, a request to use the code to open the payment channel. The mobile device may be represented by user device 110 described above.

Step 503 may include receiving, from merchant system 142, information indicative of a payment to be made to the account of the merchant via the payment channel. Merchant system 142 may provide payment information in accordance with step 306 of FIG. 3. Additionally, steps 504, 505, 506, and 507 may be performed in the manner of steps 404, 405, 406 and 407, respectively.

In additional embodiments, instead of server system 120 requesting geolocation information in accordance with steps 207 or 404, and receiving the geolocation information in accordance with steps 208 or 405, user device 110 may provide the geolocation under other contexts. For example, user device 110 may provide the geolocation at any suitable time, at the command of user 105 when user 105 has decided to use the code to make a payment. In such examples, step 404 may be omitted.

In additional embodiments, instead of server system 120 requesting geolocation information in accordance with steps 307 or 504, and receiving the geolocation information in accordance with steps 308 or 505, user device 110 may provide the geolocation under other contexts. For example, user device 110 may provide the geolocation at step 305 or 502. That is, in the method of FIG. 4, steps 402 and 405 may be performed as a single step (e.g., as part of the request to use the code to open the payment channel), and step 404 may be omitted.

According to the techniques described in this disclosure, a custom code may be used to create and open a payment channel, either for a single transaction such as a drive-through transaction or for a longer duration such as for opening a tab at a bar. The payment channel for longer-term channels can be monitored by the user for fraud. Additionally, proper usage of the payment channel may be validated based on sensor data such as geolocation information. Accordingly, the systems and methods of the present disclosure enable the ability to make and receive payments, by or from a verified customer, without requiring the customer to hand over a credit card.

In general, any method discussed in this disclosure that is understood to be computer-implementable, such as the methods described in connection with FIGS. 2-5, may be performed by one or more processors of a computer system, such as user device 110, merchant system 142, or server system 120, as described above. A method or method step performed by one or more processors may also be referred to as an operation. The one or more processors may be configured to perform such processes by having access to instructions (e.g., software or computer-readable code) that, when executed by the one or more processors, cause the one or more processors to perform the processes. The instructions may be stored in a memory of the computer system. A processor may be a central processing unit (CPU), a graphics processing unit (GPU), or another type of processing unit.

A computer system, such as user device 110, merchant system 142, and/or server system 120, may include one or more computing devices. If the one or more processors of the computer system is implemented as a plurality of processors, the plurality of processors may be included in a single computing device or distributed among a plurality of computing devices. If a computer system comprises a plurality of computing devices, the memory of the computer system may include the respective memory of each computing device of the plurality of computing devices.

FIG. 6 illustrates an example of a computing device 600 of a computer system. The computing device 600 may include processor(s) 610 (e.g., CPU, GPU, or other processing unit), a memory 620, and communication interface(s) 640 (e.g., a network interface) to communicate with other devices. Memory 620 may include volatile memory, such as RAM, and/or non-volatile memory, such as ROM and storage media. Examples of storage media include solid-state storage media (e.g., solid state drives and/or removable flash memory), optical storage media (e.g., optical discs), and/or magnetic storage media (e.g., hard disk drives). The aforementioned instructions (e.g., software or computer-readable code) may be stored in any volatile and/or non-volatile memory component of memory 620. The computing device 600 may, in some embodiments, further include input device(s) 650 (e.g., a keyboard, mouse, or touchscreen) and output device(s) 660 (e.g., a display, printer). The aforementioned elements of the computing device 600 may be connected to one another through a bus 630, which represents one or more busses.

Instructions executable by one or more processors may be stored on a non-transitory computer-readable medium. Therefore, whenever a computer-implemented method is described in this disclosure, this disclosure shall also be understood as describing a non-transitory computer-readable medium storing instructions that, when executed by one or more processors, configure and/or cause the one or more processors to perform the computer-implemented method. Examples of non-transitory computer-readable medium include RAM, ROM, solid-state storage media (e.g., solid state drives), optical storage media (e.g., optical discs), and magnetic storage media (e.g., hard disk drives). A non-transitory computer-readable medium may be part of the memory of a computer system or separate from any computer system.

It should be appreciated that in the above description of exemplary embodiments, various features are sometimes grouped together in a single embodiment, figure, or description thereof for the purpose of streamlining the disclosure and aiding in the understanding of one or more of the various inventive aspects. This method of disclosure, however, is not to be interpreted as reflecting an intention that the claimed invention requires more features than are expressly recited in each claim. Rather, as the following claims reflect, inventive aspects lie in less than all features of a single foregoing disclosed embodiment. Thus, the claims following the Detailed Description are hereby expressly incorporated into this Detailed Description, with each claim standing on its own as a separate embodiment of this disclosure.

Furthermore, while some embodiments described herein include some but not other features included in other embodiments, combinations of features of different embodiments are meant to be within the scope of the disclosure, and form different embodiments, as would be understood by those skilled in the art. For example, in the following claims, any of the claimed embodiments can be used in any combination.

Thus, while certain embodiments have been described, those skilled in the art will recognize that other and further modifications may be made thereto without departing from the spirit of the disclosure, and it is intended to claim all such changes and modifications as falling within the scope of the disclosure. For example, functionality may be added or deleted from the block diagrams and operations may be interchanged among functional blocks. Steps may be added or deleted to methods described within the scope of the present disclosure.

The above disclosed subject matter is to be considered illustrative, and not restrictive, and the appended claims are intended to cover all such modifications, enhancements, and other implementations, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description. While various implementations of the disclosure have been described, it will be apparent to those of ordinary skill in the art that many more implementations and implementations are possible within the scope of the disclosure. Accordingly, the disclosure is not to be restricted.

1. A computer-implemented method for payment processing, the method comprising:
receiving, from a mobile device associated with a user, a code and a request to enable the code to be usable to open a payment channel for receiving payment from an account of the user, wherein the code is generated by the mobile device based on instructions from the user and the request includes a time limit corresponding to a period of time during which the code is usable to open the payment channel;
receiving, from a merchant system associated with a merchant, a request to use the code to open the payment channel, the code being identifiable from the request to use the code to open the payment channel;
receiving, from the merchant system, an indication that the payment channel is open, wherein a transfer of payment to an account of the merchant is enabled after the opening of the payment channel;
receiving, from the merchant system, information indicative of the payment to be made to the account of the merchant via the payment channel;
sending, to the mobile device, a request to provide geolocation information indicative of a geolocation of the mobile device;
receiving, from the mobile device, the geolocation information determined by the mobile device using wireless hardware located on the mobile device;
determining whether two or more conditions for payment verification are satisfied, the two or more conditions including (1) a location match between the geolocation of the mobile device indicated by the geolocation information and a point of sale location of the merchant and (2) receipt of the request to use the code to open the payment channel occurs during the period of time; and
upon determining that the two or more conditions for payment verification are satisfied, processing the payment.

2. (canceled)

3. The method of claim 1, further comprising:
receiving, from the merchant, a bill item having a charge to be included in a bill; and
upon receiving the bill item, sending, to the mobile device, information describing the bill item so that the mobile device is usable to monitor updates to the bill,
wherein the payment is for the bill.

4. The method of claim 1, wherein
the payment is for a single transaction, and
the request to use the code and the information indicative of the payment are received concurrently.

5. The method of claim 1, further comprising:
sending, to the mobile device, a request to provide approval of the payment; and
receiving, from the mobile device, the approval,
wherein the one or more conditions for payment verification further include receipt of the approval from the mobile device.

6. The method of claim 1, further comprising:
receiving, from the mobile device, a pre-approval instruction indicating that approval of the payment by the user is not required for the processing the payment.

7. The method of claim 1, wherein the location match is determined to be satisfied if the location of the mobile device is within a threshold proximity from the point of sale location of the merchant.

8. The method of claim 7,
wherein the location match is determined based on one or more sets of geographic coordinates.

9. The method of claim 1, wherein the code is a license plate number.

10. The method of claim 1, further comprising:
sending, to the mobile device, a notification indicating that the payment has been processed.

11. The method of claim 1, wherein the processing the payment includes sending transaction information describing the payment to an issuer.

12. A computer-implemented method for payment processing, the method comprising:
receiving, from a merchant system associated with a merchant, a code and a request to enable the code to be usable to open a payment channel for making payments to an account of the merchant, wherein the code is generated by the merchant system based on instructions from the merchant;
receiving, from a mobile device associated with a user, a request to use the code to open the payment channel, the code being identifiable from the request to use the code to open the payment channel, wherein the request includes a time limit corresponding to a period of time during which the code is usable to open the payment channel;
receiving, from the mobile device associated with the user, an indication that the payment channel is open, wherein a transfer of payment to the account of the merchant is enabled after the opening of the payment channel;
receiving, from the merchant system, information indicative of the payment to be made to the account of the merchant via the payment channel;
sending, to the mobile device, a request to provide geolocation information indicative of a geolocation of the mobile device;
receiving, from the mobile device, the geolocation information determined by the mobile device using wireless hardware located on the mobile device;
determining whether two or more conditions for payment verification are satisfied, the two or more conditions including (1) a location match between the geolocation of the mobile device indicated by the geolocation information and a point of sale location of the merchant and (2) receipt of the request to use the code to open the payment channel occurs during the period of time; and
upon determining that the two or more conditions for payment verification are satisfied, processing the payment.

13. (canceled)

14. The method of claim 12, further comprising:
receiving, from the merchant, a bill item having a charge to be included in a bill; and
upon receiving the bill item, sending, to the mobile device, information indicative of the bill item so that the mobile device is usable to monitor updates to the bill,
wherein the payment is for the bill.

15. The method of claim 12, wherein
the payment is for a single transaction, and
the request to use the code and the information indicative of the payment are received concurrently.

16. The method of claim 12, further comprising:
sending, to the mobile device, a request to provide approval of the payment; and
receiving, from the mobile device, the approval,
wherein the one or more conditions for payment verification further include receipt of the approval from the mobile device.

17. The method of claim 12, further comprising:
receiving, from the mobile device, a pre-approval instruction indicating that approval of the payment by the user is not required for the processing the payment.

18. The method of claim 12, wherein the location match is determined to be satisfied if the location of the mobile device is within a threshold proximity from the point of sale location of the merchant.

19. The method of claim 12, further comprising:
sending, to the mobile device, a notification indicating that the payment has been processed.

20. A computer system for payment processing, the computer system comprising:
a memory storing:
instructions; and
a code associated with an account of a first party, wherein the code is generated by a computer system associated with the first party or a computer system associated with a second party; and
one or more processors configured to execute the instructions to perform operations including:
receiving, from the computer system associated with the second party, a request to use the code to open a payment channel associated with the account of the first party, the code being identifiable from the request, wherein the request includes a time limit corresponding to a period of time during which the code is usable to open the payment channel;
receiving, from the computer system associated with the first party, an indication that the payment channel is open, wherein a transfer of a payment between the first party and the second party is enabled after the opening of the payment channel;
receiving, from the computer system, information describing the payment to be made via the payment channel as part of a transaction between the first party and the second party, wherein one of the first party and the second party is a customer associated with a mobile device, and another of the first party and the second party is a merchant;
sending, to the mobile device, a request to provide geolocation information indicative of a location of the mobile device;
receiving, from the mobile device, the geolocation information determined by the mobile device using wireless hardware located on the mobile device;
determining whether two or more conditions for payment verification are satisfied, the one or more conditions including (1) a location match between the location of the mobile device indicated by the geolocation information and a point of sale location of the merchant and (2) receipt of the request to use the code to open the payment channel occurs during the period of time; and
upon determining that the two or more conditions for payment verification are satisfied, processing the payment.
